(19) United States
(12) Patent Application Publication
(10) Pub. No.: US 2006/0069220 A1
(43) Pub. Date: Mar. 30, 2006

(54) Process for preparing an alkoxylated alcohol or phenol

(76) Inventors: Jan Hermen Hendrik Meurs, Amsterdam (NL); Wilhelmina Cornelia Verhoef-Van Wijk, Amsterdam (NL); Arie Van Zon, Amsterdam (NL)

Correspondence Address: SHELL OIL COMPANY, P O BOX 2463, HOUSTON, TX, 772522463, US

(21) Appl. No.: 11/232,047

(22) Filed: Sep. 21, 2005

(30) Foreign Application Priority Data
Sep. 28, 2004 (EP) 04255928.6

(51) Int. Cl. C08F 4/44

(52) U.S. Cl. 526/160

(57) ABSTRACT

Process for preparing an alkoxylated alcohol comprising reacting a starting monohydroxy alcohol selected from secondary alcohols, tertiary alcohols and mixtures thereof with an alkylene oxide in the presence of hydrogen fluoride and a boron-containing compound comprising at least one B—O bond. The alcohol may also be a primary monohydroxy alcohol when the boron containing compound is boric acid or boric acid anhydride or a mixture thereof, or may be a primary mono hydroxy alcohol, except a C₁₄/C₁₅ alcohol when reacted with ethylene oxide in the presence of HF and trimethyl borate. A phenol may be alkoxylated in the same way instead of the mono-hydroxyalcohol.

### FIELD OF THE INVENTION

The present invention relates to a process for preparing an alkoxylated alcohol or phenol.

### BACKGROUND OF THE INVENTION

A large variety of products useful, for instance, as nonionic surfactants, wetting and emulsifying agents, solvent, and chemical intermediates, are prepared by the addition reaction (alkoxylation reaction) of alkylene oxides (epoxides) with organic compounds having one or more active hydrogen atoms. For example, particular mention may be made of the alkanol ethoxylates and alkyl-substituted phenol ethoxylates prepared by the reaction of ethylene oxide with aliphatic alcohols or substituted phenols either being of 6 to 30 carbon atoms. Such ethoxylates, and to a lesser extent corresponding propoxylates and compounds containing mixed oxyethylene and oxypropylene groups, are widely employed as nonionic detergent components of commercial cleaning formulations for use in industry and in the home.

An illustration of the preparation of an alkanol ethoxylate (represented by formula III below) by addition of a number (k) of ethylene oxide molecules (formula II) to a single alkanol molecule (formula I) is presented by the equation

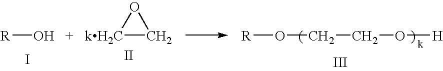

The term “alkoxylate”, as used herein, refers to any product of the addition reaction of a number (k) of alkylene oxide molecules to a single active hydrogen containing organic compound.

Alkylene oxide addition reactions are known to produce a product mixture of various alkoxylate molecules having different numbers of alkylene oxide adducts (oxyalkylene adducts), e.g. having different values for the adduct number k in formula III above. The adduct number is a factor which in many respects controls the properties of the alkoxylate molecule, and efforts are made to tailor the average adduct number of a product and/or the distribution of adduct numbers within a product to the product's intended service.

In the preparation of alkoxylated alcohols it is often the case that primary alcohols are more reactive, and in some cases substantially more reactive than the corresponding secondary and tertiary compounds. For example, this means that it is not always possible to directly ethoxylate secondary and tertiary alcohols successfully since the reactions with the starting alcohol can be slow and can lead to a high proportion of unreacted secondary and tertiary alcohols, respectively, and the formation of secondary alcohol ethoxylates and tertiary alcohol ethoxylates, respectively, with a very wide ethylene oxide distribution.

Secondary alcohols can be derived from relatively cheap feedstocks such as paraffins (by oxidation), such as those paraffins produced from Fischer-Tropsch technologies, or from short chain C₆-C₁₀ primary alcohols (by propoxylation). For this reason it would be desirable to develop a suitable process for the direct alkoxylation of secondary alcohols.

### SUMMARY OF THE INVENTION

It has surprisingly been found by the present inventors that secondary and tertiary alcohols, as well as primary alcohols, may be successfully alkoxylated by carrying out the alkoxylation reaction in the presence of hydrogen fluoride and a boron-containing compound.

According to the present invention there is provided a process for preparing an alkoxylated alcohol which comprises reacting a starting mono-hydroxy alcohol selected from the group consisting of secondary alcohols, tertiary alcohols, and mixtures thereof with an alkylene oxide in the presence of hydrogen fluoride and a boron-containing compound comprising at least one B—O bond.

According to a further aspect of the present invention there is provided a process for preparing an alkoxylated primary alcohol comprising reacting a primary mono-hydroxy alcohol with an alkylene oxide with an alkylene oxide in the presence of hydrogen fluoride and a boron-containing compound comprising at least one B—O bond excluding a process wherein a C14/C15 primary alcohol is reacted with ethylene oxide in the presence of hydrogen fluoride and trimethyl borate.

According to a further aspect of the present invention there is provided a process which comprises reacting a primary mono-hydroxy alcohol with an alkylene oxide in the presence of hydrogen fluoride and a boron-containing compound comprising at least one B—O bond, wherein the boron-containing compound is selected from the group consisting of boric acid and boric acid anhydrides.

### DETAILED DESCRIPTION OF THE INVENTION

The alkoxylated products of this invention may contain reduced levels of free unreacted alcohol and have a narrow range of alkylene oxide adduct distribution compared to the adducts prepared with an alkali metal hydroxide catalyst. The process of production of the alkoxylated products of this invention is usually easier and more flexible than that with a double metal cyanide (DMC) catalyst, as the reaction temperature may be varied over a wide range e.g. −20 to 150° C. and the catalyst is usually simpler to use than the DMC catalyst which requires a complex catalyst synthesis. The process of the invention may also give a much higher yield of alkoxylated product compared to use as catalyst of alkali metal hydroxide or hydrogen fluoride in the absence of boron containing compound with at least one B—O bond.

The process according to one aspect of the present invention comprises reacting a starting mono-hydroxy alcohol selected from secondary alcohols, tertiary alcohols and mixtures thereof with an alkylene oxide in the presence of hydrogen fluoride and a boron-containing compound comprising at least one B—O bond.

While the process of the present invention gives particular advantages versus conventional processes for the alkoxylation of secondary and tertiary alcohols in terms of providing a way to directly ethoxylate secondary and tertiary alcohols to give ethoxylated alcohol products having low levels of unreacted, residual alcohol and a narrow ethoxylate distribution, the process of the present invention is also suitable for the alkoxylation of primary mono-hydroxy alcohols.

Suitable starting alcohols for use in the preparation of alkoxylated alcohols herein include alkanols, such as ones of 1 to 30 carbon atoms. Preference may also be expressed, for reasons of both process performance and commercial value of the product, for alcohols in particular alkanols having from 6 to 30 carbon atoms, 9 to 30 carbon atoms, with C₉ to C₂₄ alcohols considered more preferred and C₉ to C₂₀ alcohols considered most preferred, including mixtures thereof, such as a mixture of C₉ and C₂₀ alcohols. As a general rule, the alcohols may be of branched or straight chain structure depending on the intended use. In one embodiment, preference further exists for alcohol reactants in which greater than 50 percent, more preferably greater than 60 percent and most preferably greater than 70 percent of the molecules are of linear (straight chain) carbon structure. In another embodiment, preference further exists for alcohol reactants in which greater than 50 percent, more preferably greater than 60 percent and most preferably greater than 70 percent of the molecules are of branched carbon structure.

The secondary starting alcohol is preferably an alkanol with one hydroxyl group, especially situated in a 2, 3, 4, 5 or 6 carbon atom chain, numbering from the end of the longest carbon chain. The alkanol is preferably linear. Non-limiting examples of secondary alcohols suitable for use herein include 2-undecanol, 2-hexanol, 3-hexanol, 2-heptanol, 3-heptanol, 2-octanol, 3-octanol, 2-nonanol, 2-decanol, 4-decanol, 2-dodecanol, 2-tetradecanol, 2-hexadecanol and mixtures thereof, especially of alkanols of the same carbon content. 2,6,8-trimethyl-4-nonanol may be used.

The tertiary alcohol starting alcohol is preferably an alkanol of 4-24, especially 9-20 carbon atoms, and may be of formula IV, R¹(R²)C(R³)OH, wherein each of R¹, R² and R³, which may be the same or different, represents an alkyl group of 1-20 carbons. R¹ preferably represents alkyl of 4-18 carbons, which may be linear or have at least one methyl or ethyl branch while R² and R³ preferably represent alkyl of 1-8 carbons, e.g., methyl, ethyl, propyl, isopropyl isobutyl, butyl or hexyl. Examples of tertiary alcohols suitable for use herein include hydroxylated mainly terminally (mainly 2- and 3-) methyl-branched C₉-C₂₀ paraffins emerging from a Fischer-Tropsch process.

Commercially available mixtures of primary monohydric alkanols prepared via the oligomerisation of ethylene and the hydroformylation or oxidation and hydrolysis of the resulting higher olefins are also suitable as starting alcohols in the process herein. Examples of commercially available primary alkanol mixtures include the NEODOL Alcohols, trademark of and sold by Shell Chemical Company, including mixtures of C₉, C₁₀ and C₁₁ alkanols (NEODOL 91 Alcohol), mixtures of C₁₂ and C₁₃ alkanols (NEODOL 23 Alcohol), mixtures of C₁₂, C₁₃, C₁₄ and C₁₅ alkanols (NEODOL 25 Alcohol), mixtures of C₁₄ and C₁₅ alkanols (NEODOL 45 Alcohol, and NEODOL 45E Alcohol); the ALFOL Alcohols (ex. Vista Chemical Company), including mixtures of C₁₀ and C₁₂ alkanols (ALFOL 1012), mixtures of C₁₂ and C₁₄ alkanols (ALFOL 1214), mixtures of C₁₆ and C₁₈ alkanols (ALFOL 1618), and mixtures of C₁₆, C₁₈ and C₂₀ alkanols (ALFOL 1620); the EPAL Alcohols (Ethyl Chemical Company), including mixtures of C₁₀ and C₁₂ alkanols (EPAL 1012), mixtures of C₁₂ and C₁₄ alkanols (EPAL 1214), and mixtures of C₁₄, C₁₆ and C₁₈ alkanols (EPAL 1418); and the TERGITOL-L Alcohols (Union Carbide), including mixtures of C₁₂, C₁₃, C₁₄ and C₁₅ alkanols (TERGITOL-L 125). Also suitable for use herein is NEODOL 1, which is primarily a C₁₁ alkanol. Also very suitable are the commercially available alkanols prepared by the reduction of naturally occurring fatty esters, for example, the CO and TA products of Procter and Gamble Company and the TA alcohols of Ashland Oil Company.

Especially preferred starting alcohols for use in the process of the present invention are secondary alcohols.

Mixtures of primary and/or secondary and/or tertiary alcohols are also suitable for use herein. For example, mixtures of primary and secondary and tertiary alcohols can be used herein. As another example, mixtures of primary and tertiary alcohols can be used herein. Mixtures of alcohols comprising primary and secondary alcohols are particularly suitable for use herein. Mixture of alcohols comprising secondary and tertiary alcohols are also particularly suitable for use herein.

In particular, oxidation products arising from Fischer-Tropsch derived paraffins (which may include mixtures of primary and secondary alcohols) are particularly suitable for use herein.

A phenol may also be alkoxylated in the same way as described herein for the alkoxylation of alcohols. In an alternative process of the present invention, there is provided process for preparing an alkoxylated phenol comprising reacting a starting mono-hydroxy phenol with an alkylene oxide in the presence of hydrogen fluoride and a boron-containing compound comprising at least one B—O bond.

The mono-hydroxy phenol may have 1-3 aromatic rings, optionally substituted with at least one inert, non hydroxylic substituent such as alkyl. The phenol may be phenol, α or β-naphthol, or be based on a phenol ring, or on a naphthol ring, either with at least 1, e.g., 1-3 alkyl substituents, each of 1-20 carbon atoms, preferably 1-3 carbon atoms such as methyl or ethyl, or 6-20 carbons such as hexyl, octyl, nonyl, decyl, dodecyl or tetradecyl. The alkyl group(s) may be linear or branched. The substituted phenol may be p-cresol or a nonylphenol, especially a linear or branched one or one which is a mixture of branched nonylphenols, optionally with n-nonyl phenol.

Suitable alkylene oxide reactants for use herein include an alkylene oxide (epoxide) reactant which comprises one or more vicinal alkylene oxides, particularly the lower alkylene oxides and more particularly those in the C₂ to C₄ range. In general, the alkylene oxides are represented by the formula (VII) 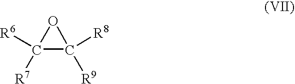
wherein each of the R⁶, R⁷, R⁸ and R⁹ moieties is preferably individually selected from the group consisting of hydrogen and alkyl moieties but may be individually selected from the group consisting of hydrogen, alkyl and hydroxyalkyl moieties with the proviso that in the formula VII there are no more than 2 hydroxyalkyl groups, e.g., one but preferably none. Reactants which comprise ethylene oxide, propylene oxide, butylene oxide, glycidol, or mixtures thereof are more preferred, particularly those which consist essentially of ethylene oxide and propylene oxide. Alkylene oxide reactants consisting essentially of ethylene oxide are considered most preferred from the standpoint of commercial opportunities for the practice of alkoxylation processes, and also from the standpoint of the preparation of products having narrow-range ethylene oxide adduct distributions.

For preparation of the alkoxylate compositions herein the alkylene oxide reactant and the starting alcohol are contacted in the presence of hydrogen fluoride and a boron-containing compound.

The hydrogen fluoride can be added as such or can be formed in-situ. Hydrogen fluoride can be formed in-situ, for example, by the use of compounds from which hydrogen fluoride can be separated off at reaction conditions. Hydrogen fluoride can be obtained by acidification with mineral acid, e.g., sulphuric acid of alkaline earth metal fluorides, e.g., calcium, strontium or barium difluoride. The HF may be generated in situ by adding to the reaction mixture a reactive fluorine-containing compound that forms HF in that mixture, such as a mixed anhydride of HF and an organic or inorganic acid. Examples of such compounds are acyl fluorides such as alkanoyl fluorides, e.g., acetyl fluoride or aryl carbonyl fluorides, benzoyl fluoride, or organic sulphonyl fluorides such as trifluoromethyl sulphonyl fluoride, or sulphuryl or thionyl fluoride. Preferably, the hydrogen fluoride is added as such to the process of the present invention. The hydrogen fluoride may be added as aqueous HF, e.g., of 30-50% by wt concentration but is preferably anhydrous.

The hydrogen fluoride is present in such an amount that it catalyses the reaction of the starting alcohol with the one or more alkylene oxides. The amount needed to catalyse the reaction depends on other reaction circumstances such as the starting alcohol used, the alkylene oxide present, the reaction temperature, further compounds which are present and which may react as co-catalyst, and the desired product. Generally, the hydrogen fluoride will be present in an amount of from 0.0005 to 10%, by weight, more preferably of from 0.001 to 5%, by weight, more preferably of from 0.002 to 1%, by weight, especially 0.05 to 0.5% by weight, based on the total amount of starting alcohol and alkylene oxide.

The presence of a boron-containing compound comprising at least one B—O bond in combination with hydrogen fluoride has been found to be particularly useful for catalyzing the reaction of an alcohol with an alkylene oxide.

Suitable boron-containing compounds comprising at least one B—O bond for use herein include boric acid (H₃BO₃), boric acid anhydrides, alkyl borates, and mixtures thereof. Suitable compounds may contain 1-3 B—O bonds, in particular 3 B—O bonds, as in boric acid or trimethyl borate.

The boron-containing compounds for use herein can either be introduced into the process as such or formed from their organoborane precursor(s) by hydrolysis or alcoholysis in-situ.

Examples of suitable boric acid anhydrides for use herein include meta boric acid (HBO₂), tetra boric acid (H₂B₄O₇) and boron oxide (B₂O₃).

Examples of suitable alkyl borates for use herein include trimethyl borate, triethyl borate, tripropyl borate, tri-isopropyl borate, tributyl borate and the boric ester derived from the starting (secondary) alcohol or its ethoxylate. Of these borates, trimethyl borate is preferred.

It is possible to prepare boron compounds having at least one B—O bond in-situ. For example, the compound 9-borabicyclo[3.3.1]nonane (BBN), which does not contain any B—O bonds, may be used to prepare 9-methoxy and/or 9-hydroxy BBN on contact with methanol or water in the reaction mixture.

Preferred boron-containing compounds for use herein are selected from boric acid, boric acid anhydrides and mixtures thereof.

Boric acid is a particularly preferred boron-containing compound for use in the present process, especially from the viewpoint of providing an alkoxylated alcohol with relatively low levels of residual alcohol and a relatively narrow alkoxylate distribution.

The boron containing compound comprising at least one B—O bond is present in such an amount that it acts as co-catalyst for the reaction of the starting alcohol with the one or more alkylene oxides. The amount needed depends on other reaction circumstances such as the starting alcohol used, the alkylene oxide present, the reaction temperature, further compounds which are present and which may react as co-catalyst, and the desired product. Generally, the boron containing compound comprising at least one B—O bond will be present in an amount of from 0.0005 to 10%, by weight, more preferably of from 0.001 to 5%, by weight, more preferably of from 0.002 to 1%, by weight, especially 0.05 to 0.5% by weight based on the total amount of starting alcohol and alkylene oxide.

The weight ratio of said boron containing compound to hydrogen fluoride is usually 100:1 to 1:100, preferably 1:10 to 10:1, especially 3:1 to 1:3.

The alkoxylation process may be performed at −20° C. to 200° C., or 0 to 200° C., but preferably 50 to 130° C. or especially at less than 70° C. or 50° C., such as 0 to 50° C., in particular to reduce byproduct formation.

In preferred alkoxylated alcohols produced by the process of the present invention, the amount of free alcohol is no more than 3%, more preferably no more than 1%, even more preferably no more than 0.5%, by weight of the alkoxylated alcohol.

At the end of the reaction, when the desired number of alkylene oxide units has been added to the alcohol, the reaction may be stopped by removal of the hydrogen fluoride and/or the alkylene oxide. The acid may be removed by adsorption, by ion exchange with a basic anion exchange resin, or by reaction such as by neutralization. The alkylene oxide may be removed by evaporation, in particular under reduced pressure and especially at less than 100° C., such as 40 to 80° C.

Examples of suitable ion exchange resins are weakly or strongly basic or anion exchange resins to remove the fluorine anion. They may be at least in part in their chloride or hydroxyl form. Examples of these resins are those sold under the Trade Mark AMBERJET 4200 and AMBERLITE IRA 400. The reaction product may be mixed with the ion exchange resin in a batch operation and subsequently separated therefrom but preferably the removal is in a continuous operation with the resin in a column through which is passed the reaction product.

Another method of inactivating the HF is by neutralization. This may be performed with a base or with a salt of a strong base and weak acid. The base or salt may be inorganic, in particular one with at least some solubility in the reaction product, such as at least 10 g/l. The neutralization agent may be an alkali metal or ammonium carbonate or bicarbonate such as sodium carbonate or ammonium carbonate or the corresponding hydroxide such as sodium hydroxide. Ammonia gas may be used. Preferably, the neutralization agent is an organic compound such as an organic amine with at least one aminic nitrogen atom, such as 1-3 such atoms. Examples of suitable amines are primary, secondary, or tertiary mono or diamines. The organic group or groups attached to the amine nitrogen[s] may be an optionally substituted alkyl group of 1-10 carbons such as methyl ethyl, butyl, hexyls or octyl, or hydroxyl substituted derivative thereof such as hydroxyethyl, hydroxypropyl, or hydroxyisopropyl, or an aromatic group such as a phenyl group optionally substituted by at least one alkyl substituent e.g. of 1-6 carbon atoms such as methyl or inert substituent such as halogen e.g. chlorine. Heterocyclic nitrogenous bases may also be used in which the ring contains one or more nitrogen atoms, as in pyridine or an alkyl pyridine. Preferably, the organic neutralization agent is a hydroxyalkyl amine, especially a mono amine, with 1, 2 or 3 hydroxyalkyl groups, the other valency(ies), if any, on the nitrogen being met by hydrogen or alkyl. The hydroxyalkyl and alkyl groups may contain 1-6 carbons such as in 2 hydroxyethyl groups. Oligoalkyleneglycolamines may also be used. The preferred amines are diethanolamine, triethanolamine, and the corresponding isopropanolamines. The basic compound may be added in amount to neutralize at least half of the hydrogen fluoride and preferably at least all of it.

Another type of agent to inactivate the hydrogen fluoride is a reagent capable with the hydrogen fluoride of forming a volatile fluoride. Silicon dioxide is an example of such a reagent as this forms silicon tetrafluoride which can be volatilised away from the alkoxylated product in a subsequent stripping stage.

The removal or inactivation of the hydrogen fluoride is usually performed at a temperature below 100° C., such as 20 to 80° C. or especially below 40° C.

The removal or inactivation of the hydrogen fluoride can be performed before or after any removal or stripping to reduce the content of volatiles such as unreacted alkylene oxide, any by-products such as 1,4-dioxane, and possibly unreacted alcohol feedstock. The removal is preferably performed under reduced pressure and may be at a temperature below 150° C., preferably below 100° C., such as 40 to 70° C. Advantageously, the removal of volatiles is aided with passage of inert gas such as nitrogen through the reaction product. When the removal of the hydrogen fluoride occurs before the stripping, any base used to neutralize the hydrogen fluoride is preferably inorganic or maybe of much higher volatility (e.g., with an atmospheric boiling point below 100° C. or an amine containing less than 6 carbon atoms) than when the stripping occurs before the removal of hydrogen fluoride. In the latter case any base is preferably inorganic or of low volatility (e.g., with an atmospheric boiling point above 150° C. or an amine containing more than 12 carbon atoms). By this means in the former case, the stripping will help to remove traces of residual volatile base. Preferably, the stripping is performed before removal of the hydrogen fluoride by addition of an amine of low volatility as described above or a non volatile amine.

After the stripping and the removal of the hydrogen fluoride, the alkoxylated product may be ready for use as such, for example, in detergents, or may be further purified, e.g., to separate unreacted alcohol and fluoride salts and/or improve its colour before use.

The invention will be further illustrated by the following examples, however, without limiting the invention to these specific embodiments.

### EXAMPLES

### Example 1

### Ethoxylation of the Secondary Alcohol 2-undecanol

To a “Teflon” bottle, equipped with a magnetic stirring bar and immersed in a (water) cooling bath, was charged with 2-undecanol (58 mmol, 10 g), boric acid (50 mg) and hydrogen fluoride (50 mg). Ethylene oxide was added in the gas-phase at atmospheric pressure, at such a rate that the temperature did not exceed 50° C. After about 3 hours, 15.8 g of ethylene oxide (358 mmol) was consumed which corresponds with a degree of ethoxylation of 6.2 on intake) and then the product was treated with ca. 50 mg of diethanol amine. The yield of ethoxylated 2-undecanol was 0.316 kg EO/per g hydrogen fluoride (HF).

Measurement of the average number of moles of ethylene oxide per mole of 2-undecanol, the ethoxylate distribution and residual free alcohol was performed using high performance liquid chromatography (HPLC). The technique for these measurements involved derivatizing the ethoxylated alcohol using 4-nitrobenzoylchloride. The product is then analyzed by Gradient Elution High Performance Liquid Chromatography using a Polygosil Amino stationary phase with an iso-hexane/ethylacetate/acetonitrile mobile phase. Detection was performed by ultra-violet absorbance. Quantification is by means of an internal normalisation technique. The results of the ethoxylate distribution and the residual free alcohol are shown in Table 1 below and are given in mass percent (% m/m=% wt/wt).

### Example 2

Ethoxylation of the Secondary Alcohol 2-undecanol

The ethoxylation of 2-undecanol was carried out using the method of Example 1 except that the reaction temperature was maintained at 70° C. Measurement of the average number of moles of ethylene oxide per mole of 2-undecanol, the ethoxylate distribution and the residual free alcohol content was carried out using the same techniques as used in Example 1. The results are shown in Table 1 below.

### Example 3

Ethoxylation of the Secondary Alcohol 2-undecanol

The ethoxylation of 2-undecanol was carried out using the method of Example 1 except that the reaction temperature was maintained at 130° C. Measurement of the average number of moles of ethylene oxide per mole of 2-undecanol, the ethoxylate distribution and the residual free alcohol content was carried out using the same techniques as used in Example 1. The results are shown in Table 1 below.

### Example 4

### Comparative

Potassium Hydroxide Catalysed Ethoxylation of the Secondary Alcohol 2-undecanol.

2-Undecanol (10.0 g) and 0.2 g potassium hydroxide were stirred at 130° C. Then 3 ml of toluene were added and removed by stripping with nitrogen (for water removal). To the remaining solution (9.9 g), the EO was dosed at atmospheric pressure and stopped after the consumption of 16.7 g of EO. After cooling the mixture was neutralized with acetic acid. The yield of ethoxylated 2-undecanols was 0.083 kg EO/g KOH.

The average number of moles of EO per molecule, the ethoxylate distribution and the level of free alcohol were measured using the same methods as used in Example 1. The results are shown in Table 1 below.

TABLE 1

| | Example No. | | | |
|---|---|---|---|---|
| | | | | Ex. 4 |
| | Ex. 1 | Ex. 2 | Ex. 3 | (comp.) |
| Average Ethoxylation | 5.9 | 6.7 | 6.2 | 6.0 |
| Number (mol/mol) | | | | |
| Ethoxylate | | | | |
| Distribution, | | | | |
| R—O—(CH₂—CH₂—O—)ₖ—OH: | | | | |
| k = 0, Residual free | 1.1 | 0.7 | 0.5 | 5.2 |
| alcohol (% wt) | | | | |
| k = 1 (% wt) | 2.5 | 1.4 | 1.5 | 3.1 |
| k = 2 (% wt) | 4.5 | 3.0 | 3.6 | 4.2 |
| k = 3 (% wt) | 8.6 | 5.1 | 6.5 | 6.3 |
| k = 4 (% wt) | 10.1 | 7.8 | 9.3 | 7.5 |
| k = 5 (% wt) | 11.0 | 10.4 | 11.7 | 8.1 |
| k = 6 (% wt) | 10.0 | 11.0 | 12.4 | 7.9 |
| k = 7 (% wt) | 9.6 | 12.0 | 12.8 | 7.4 |
| k = 8 (% wt) | 8.3 | 9.7 | 9.2 | 6.8 |
| k = 9 (% wt) | 8.1 | 10.0 | 8.7 | 6.0 |
| k = 10 (% wt) | 7.5 | 7.1 | 6.8 | 5.7 |
| k = 11 (% wt) | 5.0 | 5.5 | 4.8 | 5.1 |
| k = 12 (% wt) | 4.3 | 4.3 | 3.5 | 4.7 |
| k = 13 (% wt) | 3.1 | 3.4 | 2.5 | 4.0 |
| k = 14 (% wt) | 2.1 | 2.5 | 2.3 | 3.5 |
| k = 15 (% wt) | 1.6 | 2.0 | 1.5 | 3.0 |
| k = 16 (% wt) | 1.4 | 1.2 | 1.0 | 2.5 |
| k = 17 (% wt) | 1.4 | 1.1 | 0.6 | 2.1 |
| k = 18 (% wt) | nd | 1.1 | 0.5 | 1.7 |
| k = 19 (% wt) | nd | 0.4 | 0.4 | 1.3 |
| k = 20 (% wt) | nd | 0.3 | nd | 1.0 |
| k = 21 (% wt) | nd | nd | nd | 0.7 |
| k = 22 (% wt) | nd | nd | nd | 0.7 |
| k = 23 (% wt) | nd | nd | nd | 0.7 |
| k = 24 (% wt) | nd | nd | nd | 0.4 |
| k = 25 (% wt) | nd | nd | nd | 0.3 |

nd = not determined

It can be clearly seen from Table 1 that the ethoxylated secondary alcohols prepared using a HF/boric acid catalyst have significantly reduced levels of free alcohol (k=0) and relatively narrow ethoxylate distributions (i.e. peaked distributions) compared to the ethoxylated secondary alcohol prepared using a conventional potassium hydroxide ethoxylation catalyst.

### Example 5 to 7

Propylene oxide (4 g) was added to an equimolar mixture of tert-butanol (0.2 mol, 14.8 g), iso-propanol (12.0 g, 0.2 mol) and ethanol (0.2 mol, 9.2 g). Then 0.1 ml of trimethyl borate was added and 0.3 ml of 48% aqueous HF. The reaction started immediately. After the consumption of the propylene oxide (about 30 min) the mixture was analyzed with GLC to show a mixture comprising mono-propoxylated derivatives of tert butanol, isopropanol and ethanol.

### Examples 8 to 10

Ethylene oxide was bubbled through an equimolar mixture of tert-butanol (0.2 mol, 14.8 g), iso-propanol (12.0 g, 0.2 mol) and ethanol (0.2 mol, 9.2 g) containing 0.1 ml of trimethyl borate and 0.3 ml of 48% aqueous HF. The temperature was kept below 30° C. After about 10 minutes the reaction was stopped and the mixture analyzed with GLC to show a mixture comprising mono-ethoxylated derivatives of tert-butanol, isopropanol and ethanol.

We claim:

1. A process for preparing an alkoxylated alcohol which comprises reacting a starting mono-hydroxy alcohol selected from the group consisting of secondary alcohols, tertiary alcohols, and mixtures thereof with an alkylene oxide in the presence of hydrogen fluoride and a boron-containing compound comprising at least one B—O bond.

2. The process of claim 1 wherein the boron-containing compound comprising at least one B—O bond is selected from the group consisting of boric acid, boric acid anhydrides, borate esters, and mixtures thereof.

3. The process of claim 2 wherein the boron-containing compound comprising at least one B—O bond is selected from the group consisting of boric acid, boric acid anhydrides and mixtures thereof.

4. The process of claim 3 wherein the boron-containing compound comprising at least one B—O bond is boric acid.

5. The process of claim 2 wherein the boron-containing compound comprising at least one B—O bond is trimethyl borate.

6. The process of claim 1 wherein the alkylene oxide is selected from the group consisting of ethylene oxide, propylene oxide, butylene oxide, glycidol, and mixtures thereof.

7. The process of claim 6 wherein the alkylene oxide is ethylene oxide.

8. The process of claim 1 wherein the process is carried out at a temperature in the range of from 0° C. to 200° C.

9. The process of claim 8 wherein the process is carried out at a temperature in the range of from 50° C. to 130° C.

10. The process of claim 1 wherein the starting alcohol is a secondary mono-hydroxy alkanol.

11. A process for preparing an alkoxylated alcohol comprising reacting a primary mono-hydroxy alcohol with an alkylene oxide in the presence of hydrogen fluoride and a boron-containing compound comprising at least one B—O bond excluding a process which comprises reacting a C14/C15 alcohol with ethylene oxide in the presence of hydrogen fluoride and trimethyl borate.

12. A process for preparing an alkoxylated alcohol comprising reacting a primary mono-hydroxy alcohol with an alkylene oxide in the presence of hydrogen fluoride and a boron-containing compound comprising at least one B—O bond wherein the boron-containing compound is selected from boric acid, boric acid anhydrides, and mixtures thereof.

13. A process for preparing an alkoxylated phenol comprising reacting a starting mono-hydroxy phenol with an alkylene oxide in the presence of hydrogen fluoride and a boron-containing compound comprising at least one B—O bond.

14. The process of claim 13 wherein the boron-containing compound comprising at least one B—O bond and the alkylene oxide is selected from the group consisting of ethylene oxide, propylene oxide, butylene oxide, glycidol, and mixtures thereof.

15. The process of claim 14 wherein the alkylene oxide is ethylene oxide.

16. The process of claim 13 wherein the boron-containing compound comprising at least one B—O bond is selected from the group consisting of boric acid, boric acid anhydrides, borate esters, and mixtures thereof.

17. The process of claim 16 wherein the boron-containing compound comprising at least one B—O bond is selected from the group consisting of boric acid, boric acid anhydrides and mixtures thereof.

18. The process of claim 17 wherein the boron-containing compound comprising at least one B—O bond is boric acid.

19. The process of claim 16 wherein the boron-containing compound comprising at least one B—O bond is trimethyl borate.

20. The process of claim 13 wherein the process is carried out at a temperature in the range of from 0° C. to 200° C.
